(19) United States
(12) Patent Application Publication
(10) Pub. No.: US 2010/0293374 A1
(43) Pub. Date: Nov. 18, 2010

(54) Secure Portable Memory Storage Device

(76) Inventor: Donald P. Bushby, Houston, TX (US)

Correspondence Address: GLENN L. WEBB;GLENN L. WEBB P.C., P.O BOX 3788, DURANGO, CO, 81302, US

(21) Appl. No.: 12/512,987

(22) Filed: Jul. 30, 2009

Related U.S. Application Data
(60) Provisional application No. 61/137,364, filed on Jul. 30, 2008.

(51) Int. Cl. G06F 12/14; H04L 9/32; H04K 1/00

(52) U.S. Cl. 713/168; 726/30; 726/21; 380/270

(57) ABSTRACT

A wireless secure authentication system for portable memory storage devices to prevent unauthorized transfer of stored data. The system includes a memory device such as a USB storage device that is capable of data storage. A wireless receiver and/or transmitter on the device receives and/or transmits an external signal from and/or to an external remote device, such as RFID card, bluetooth receiver, cellular telephone or any other wireless device. The device does not allow data to be accessed in the memory of the device until it receives an appropriate signal from the external device. Once the appropriate signal has been received, data transfer is allowed. In the event that the signal is lost, the data transfer is terminated and access to the data is not permitted. Examples of the system includes a USB memory device that requires a RFID card with an encrypted signal to be within a dedicated perimeter from the device.

### RELATED APPLICATIONS

This application claims the benefit of provisional patent application 61/137,364, filed on Jul. 30, 2008.

### FIELD OF THE INVENTION

The present invention is directed to a portable memory storage device (PMSD) and security system which requires a signal from a device external to the PMSD to enable data transfer from the PMSD to a host computer or other external memory containing device.

### BACKGROUND OF THE INVENTION

Portable Memory Storage Devices (PMSD) are small devices capable of storing data. Presently, devices of this type often carry relatively large amounts of data. These devices often use Flash memory as well as other types of nonvolatile computer readable medium. The storage capability available of PMSDs found in the market place is ever increasing and price per unit of memory decreasing. PMSDs are characterized by their small size. These devices often easily fit in ones hand, or can be conveniently carried in an individual's pocket. Flash drives, thumb drives, mini hard drives, are examples of PMSDs.

PMSDs are often connected to a computer via a universal serial bus (USB) connection, edge connectors as well as other types of connection mechanisms. A Universal Serial Bus (“USB”) is an external bus that supports plug and play installation. Using a USB port of a computer system, a user may connect and disconnect devices without shutting down or restarting the computer. USB devices are described further in the Universal Serial Bus Specification available at www.usb.org/developers/devclass_docs/usbmass-ufi10.pdf.

The small size of these devices, while convenient to user, creates a vulnerability of easy misplacement or loss of theses device. The small size and high data storage capability of these devices posses a high risk to the data owners. The risk is that the data on these devices can be easily and discretely “borrowed” by unauthorized users (i.e. also known as “data leakage”). The device can also simply be lost or misplaced falling into undesirable hands. This potential of data loss/leakage to unauthorized users is a risk to private individuals, corporations, and many other organizations. For example: A lost PMSD left in a coffee shop or airplane posses a risk to the data owner, of unauthorized and undesirable use of the data contained within. Once the device is outside the authorized users' control, the user has no means of disabling access to portions or blocks of the PMSDs memory or preventing its use.

Password protection methods are available for these devices. However compliance with these techniques is often low, not foolproof and not easily auditable to ensure compliance. Encryption techniques can also be employed but again are not easily auditable to ensure compliance and are often complicated and inconvenient to use.

Authentication factors are sometimes used to prevent unauthorized access to data. An authentication factor is a piece of information and process used to authenticate or verify a person's identity for security purposes. A two-factor authentication (T-FA) is a system wherein two different factors are used to authenticate. The greater the levels of authentication the higher the level of assurance can be obtained that the user is an authorized user. Authentication techniques may be employed directly in a PMSD. For example: password protection may be used in the PMSD and the data stored may be encrypted. However the use of authentication factors, particular two or more factor authentication is cumbersome and seldom complied with in data storage for most users. One PMSD (a flash drive) currently on the market utilizes a built in keypad, to allow the user to enter a passcode. However, entering data or operating inputs located directly on a PMSD (e.g. flash drive) is awkward due to the small size of the devices particularly if connected to a host computer at the time of data entry.

What is needed is: a convenient system of preventing unauthorized access (i.e. disabling communications to and from the memory via the connector) to potentially sensitive data stored on a PMSD once the device is outside its owner's direct control, a convenient means of wirelessly authenticating PMSD users, a convenient means to utilize user inputs in the authentication process, a two part system requiring presence of both parts to enable the data access process, and a security system which adds an addition, automatic and convenience layer of user authentication which is also compatible with existing security techniques (e.g. password, encryption, and biometrics).

### SUMMARY OF THE INVENTION

The present invention provides a secure system for storing information on a portable device with greatly diminished risk of unauthorized access to the information. The PMSD and security system provides data security by preventing data transfer from secure sections of the PMSD's memory when an external signal (10) is not present to enable the data transfer process.

A preferred embodiment of the PMSD includes a memory storage, a receiver, a controller and a connector associated with the memory storage for transmitting digital data to an external host. The PMSD blocks access to the memory storage until the controller enables the transfer. This enablement does not occur until the receiver on the PMSD receives an external wireless signal. This signal is then communicated to the controller. The controller is a multi-state device which inhibits or enables data transfer between the memory storage of the PMSD and a host device to which the PMSD is connected. The normal state of the controller is to inhibit data transfer. Once the controller receives a valid signal from the receiver, it then enables the data transfer process.

In another preferred embodiment, the controller includes a decision component. The decision component compares the signal received from the external source to predetermined criteria to determine if the signal is valid for authentication purposes. If the signal is determined to be valid, then it communicates that validity to the controller for enabling data transfer.

In another preferred embodiment of the present invention, the PMSD includes a computer readable medium partitioned into public and private partitions. The public partition may be accessible through normal channels of access. The private partition may be accessed only through the authentication or validation process, using an external wireless signal. As described above, the controller prevents access to the private partition until it receives a valid signal.

In another preferred embodiment, the external wireless signal is transmitted from a remote device, referred to herein as a “remote enabler”. The external signal generating device or remote enabler may by way of example be a small pocket sized item (e.g. a FOB) attached to a key chain or disguised as jewelry and kept on the user separate from the PMSD. Other examples of external devices capable of generating a wireless signal for use in the authentication process could include a Bluetooth device such as a cell phone.

The external device may alternatively be a simple device with capable of transmitting a signal, continuously, randomly, time based, or on command (potentially via a simple manual activated switch) in which authorization in the PMSD is based on characteristics of the signal received such as amplitude, frequency or signal pattern. The device may alternatively be worn like a military “dog tag” that is worn by military personnel or a corporate “smart card” worn as a badge by corporate or governmental employees.

The remote device could also be a proximity card. Proximity cards or simply “prox cards”, like contactless smart cards, communicate through an embedded antenna to a remote receiver. Unlike smart cards, prox cards are read-only devices. It is not possible to write information back on to the card's chip. Prox cards also generally have a greater range of operation than smart cards-from 2.5″ to 20″ (63.5 mm to 508 mm), depending on the reader. The amount of information prox cards store is relatively small.

Another form of remote devices include radio frequency identification, or RFID. RFID is a generic term for technologies that use radio waves to automatically identify people or objects. There are several methods of identification, but the most common is to store a serial number that identifies a person or object, and perhaps other information, on a microchip that is attached to an antenna (the chip and the antenna together are called an RFID transponder or an RFID tag). RFID tag data is typically static (i.e. of a fixed value), not encrypted or able change on its value or frequency. An RF antenna enables the chip to transmit the identification information to a reader. The reader converts the radio waves reflected back from the RFID tag into digital information that can then be passed on to computers that can make use of it. RFID tags and readers have to be tuned to the same frequency to communicate. RFID systems use many different frequencies, but generally the most common are low-frequency (around 125 KHz), high-frequency (13.56 MHz) and ultra-high-frequency or UHF (860-960 MHz). Microwave (2.45 GHz).

In another preferred embodiment, the PMSD includes a transmitter that pings the external device. Once the external device is within range, the device receives the signal transmitted from the PMSD and transmits an authentication signal back to the PMSD to enable the data transfer.

Another preferred embodiment utilizes additional layers or forms of authentication. The user is required to input additional authentication credentials into the remote device, such as passwords, biometric data or other information. This information is transmitted to the PMSD to authenticate the user and to allow the data to be transferred from the PMSD to the host device.

These and other features of the present device will be evident from the ensuing detailed description of preferred embodiments, from the drawings and from the claims.

### BRIEF DESCRIPTION OF THE DRAWINGS

FIG. 1 is an overview of the system of a preferred embodiment.

FIG. 2 illustrates a remote enabler for use with the system of the embodiment of FIG. 1.

FIG. 3 illustrates a block diagram of a preferred embodiment of PMSD and the remote enabler.

FIG. 4 illustrates a block diagram of another preferred embodiment.

FIG. 5 illustrates a block diagram of another preferred embodiment.

FIG. 6 illustrates a block diagram of another preferred embodiment.

### DETAILED DESCRIPTION OF PREFERRED EMBODIMENTS

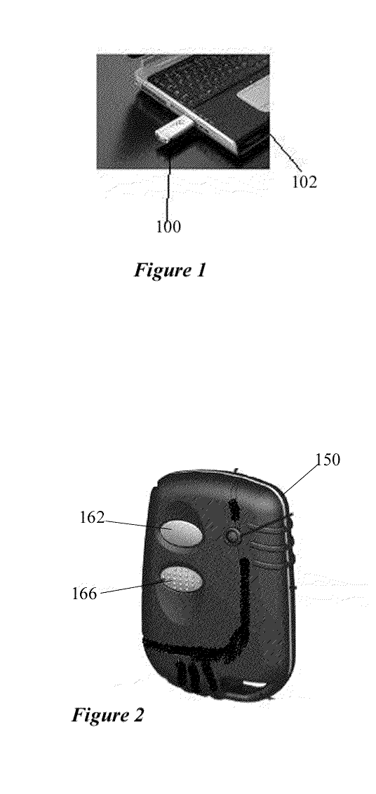

A preferred embodiment of the present invention is illustrated in FIGS. 1-6. It is to be expressly understood that the descriptive embodiments are provided herein for explanatory purposes only and are not meant to unduly limit the claimed inventions. The exemplary embodiments describe the present invention in terms of a portable memory storage device as shown in FIGS. 1-6. It is to be understood that the present invention is intended for use with PMSDs, with “portable” defined as weighing less than 1 lb, hand held, or pocket sized devices. However, other types of memory storage devices could benefit from the disclosed invention; such devices may include laptop computers, servers, or desktop computers, and other electronic devices. For the purpose of illustrating the invention, there is shown in the drawings, certain embodiments. It should be understood, however, that the present invention is not limited to the arrangements and instrumentality shown in the attached drawings. It is understood that the functionality of the components shown could be combined, or swapped in relation to each other to perform the same intended function without deviating from the scope of the present invention. The functionality described may be performed by hardware (e.g. firmware), software, or any combination without deviating from the scope of the present invention.

### Summary of a Preferred Embodiment of the System

A preferred embodiment of the present invention is illustrated in FIG. 1. This embodiment includes a PMSD (100), a wireless signal 200 (not shown), and a host device (102) (such as a computer). The wireless signal 200 is generated by an external source, such as a “remote enabler” or another source as discussed in greater detail below. The wireless signal 200 when received by the receiver of the PMSD is validated via a validation process/authentication process. Once the signal is validated, access is authorized to data or applications stored on the PMSD.

A user may use the secure PMSD (100) by wearing or carrying a “remote enabler” (150) which, when used with a PMSD of the present system, automatically recognizes and validates the user. This allows access to the information stored in the PMSD. The information is not accessible unless the remote enabler (150) is within range and activated. In the event that the PMSD is left unattended and outside of the users control (and outside the range of the wireless signal), access to the information that is securely stored on the PMSD is denied. Further, even after authentication, the PMSD may automatically disable the data transfer process based on signal degradation or loss, disconnection of the PMSD from the host, or by manual input to the “remote enabler” (such as a “disable” command) given while the devices are within range.

Users such as a corporate users may use such a system to prevent unauthorized data access by third parties in the event a PMSD (100) (such as a USB flash drive) is left in a coffee shop, airplane, any public place or in any unsecured location, such as in a desk drawer or lying on a table. The unauthorized party which may acquire access or control of the PMSD, would be restricted from accessing data stored within protected portions of the memory by not having the remote enabler (150) to enable the data transfer process to a potential host.

Public portions of the memory may be readily accessible by other authentication, such as password, biometrics or other. Public memory sections may be used to allow the device to function as “plug and play”. Indicator(s) may be used to indicate which portions of the memory are enabled.

The features of the system and of a preferred embodiment as well as other embodiments are discussed in greater detail below.

### Types of PMSD

The PMSD of the present invention may be any type of portable memory storage devices that are currently or previously being used to store data, applications or other information as well as devices that may be developed in the future for storing data. For example and without limitation, PMSDs include universal serial bus flash drives, memory cards, flash memory devices, hard drives, and any other form of computer readable memory storage.

The PMSD may be “plug and play” and may use a USB or other suitable connector to connect to a host device. The connector mechanism: may or may not have a housing, and could be as simple a conductor suitable for connection and transferring data to a host device. By way of example: a set of electrical conductors forming an edge connection is a form of connector mechanism. The PMSD contains all required elements such as a receiver, decision component, memory and interface devices. The PMSD may also include indicators such as LEDs. The indicators may indicate the state of communications, power or data access to the memory. The receiver in the PMSD after receiving a signal and executing a validation process utilizing a decision component, will via the use of a controller (i.e. a device with at least two output states), enable data access from a host device to the memory or portion of memory contained in the PMSD, via a physical (hardwired) connection via the connector interface and the connector and the host devices port. The PMSD may be configured to require a signal only to enable data transfer process, the process may remain enabled: until the PMSD is disconnected from the host, until a timer times out, until the transfer process is disabled by a remote “disable” signal, or until manually disabled via an input device directly to the PMSD or to the remote enabler, until the PMSD is powered down, or by other schemes for disabling may use any combination of the above. Alternatively the data transfer process from PMSD to host may be disabled simply by loss or degraded signal.

### Types of External Signal Sources

The external signal source can be any form of wireless transmission. The source may be a remote enabler as described below that can be carried or worn by a user, or it can be a fixed broadcast source such as a Wi-Fi or Wi-Max signal. The wireless signal can also be an infrared, a radio frequency, an acoustic, an ultraviolet frequency, an optical frequency or a magnetic field or others. The signal may use any known standard or protocol including without limitation, HID, Indala, EM, Mifare or i-Class as well as others. The signal may be encrypted or non-encrypted.

The remote enabler (150), in a preferred embodiment as shown in FIG. 2, is a small device that can be carried by a user. The device may fit in a pocket or even be small enough to fit in a wallet, like a credit card, RFID tag or worn as jewelry. The remote device, in a preferred embodiment would operate using a radio frequency signal, providing a signal to the PMSD whenever the user carrying the device is in range of the PMSD. The remote enabler provides a “wireless” (i.e. not requiring physical contact) form of communication to the PMSD. In a preferred embodiment the remote enabler would be a powered device including a switch to allow selection of continuous or intermittent (e.g. signal on demand) modes of operation and may have an indicator, indicating status of transmission, battery condition or other conditions.

The PMSD, as discussed in greater detail below, would, after performing a validation process, enable communication between the PMSD and a physically connected host device via its connector (i.e. when the validation/authentication process yields acceptable results). Communication could be allowed continuously until the PMSD is unplugged from the host, disconnected automatically after a time delay period or until the signal has been lost (or degraded) for a period of time (which could be immediately).

The remote enabler may also be a transceiver (i.e. special transmitter and receiver combination) or an RFID tag device. In one preferred embodiment the remote enabler would include a transmitter and power supply, and produce a radio frequency signal (potentially following protocols such as bluetooth or zigbee). However, it is understood that infrared receiver, a radio frequency receiver, an acoustic receiver, an ultraviolet frequency receiver, an optical frequency receiver, a magnetic field data receiver, and any other wireless media could be used, with out deviating form the scope of the present invention.

In a preferred embodiment, the remote enabler allows the transmission frequency to be actively changed. The active frequency enablement allows the frequency to be changed to improve the security of the device. The user can change the broadcast frequency of the enabler and the PMSD to prevent duplication of devices or cloned devices. It also allows the remote enabler to be used with multiple PMSDs, each with either the same or different frequencies.

The remote enabler may also include the use of tokens, such as encrypted signals or time varying signals. This improves the security to prevent cloning of the signal, and also to verify that authorization is still in effect.

In another preferred embodiment, the remote enabler is a Radio Frequency Identification tag (RFID tag). In this embodiment, the receiver on the PMSD would be an RFID reader. The RFID tag includes an integrated circuit for storing and processing signals, modulating and demodulating a radio-frequency signal and other functions as well as an antenna for receiving and transmitting signals. It also, in one embodiment, can alter the transmission frequency to allow use with multiple devices or to improve security. The tag can be integrated into a card, badge, employee identification badge, or on a fob or any other form. The RFID tag can include a battery for either active or battery assisted passive or other power source or it can eliminate the power supply all together and operate passively.

The user in this case would wave the RFID tag within the readable range of the RFID reader of the PMSD system. This range can be up to 30 feet or greater in some cases. Authentication of the user via the RFID tag would then be used to enable communications between the PMSD and a host. Lost of connection to the host could be detected by the PMSD and used to reset the authentication process (i.e. requiring re-authentication prior to the next use of the device). The communications which are being enabled via the remote device (RFID tag in this example) may, by way of example may be from secure portions of memory.

The remote enabler, in a preferred embodiment, includes an input mechanism that allows additional criteria to be broadcast to the PMSD. These additional criteria, as discussed in greater detail below, can be passwords, biometrics, a switch, or other security features. Since the remote enabler can be hand held, it is much easier to include these additional inputs rather than directly onto the PMSD.

The remote enabler may also include a number of other features to improve it's functionality and security. These features include a selectable range, such as close proximity, within room range, building range or campus range. It may also include the ability to be turned on or off to control the enablement of the PSMD. The remote enabler may also be able to broadcast continuously or on demand to selectively enable or disable the PSMD. The remote enabler may also include selectable signals to operate different PSMD devices.

Other types of wireless signal sources that are presently known or later developed are also considered to be within the scope of the present invention. The above examples are provided for descriptive purposes only and are not meant to limit the scope of the invention.

### First Preferred Embodiment

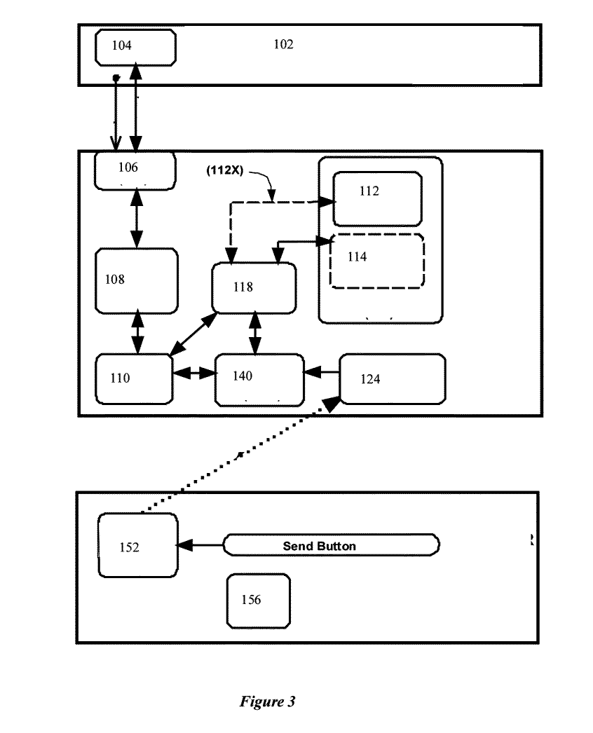

A first preferred embodiment of the present invention is illustrated in FIG. 3. The system is shown in a block diagram that includes a PMSD 100 and a remote enabler 150. The PMSD, in this embodiment, is a Universal Serial Bus (USB) flash drive. The USB flash drive 100 includes a controller 110, a USB interface 108 and a computer readable medium interface 118. The USB flash drive includes a nonvolatile computer readable medium 116 which may include one or more flash memories 112, 114 that is controlled by the controller 110 through the nonvolatile computer readable medium interface 118. The controller 110 may also access appropriate firmware 120 such as an operating system to control the operation and function of the USB connector and the nonvolatile computer readable memory

The USB flash drive 100 also includes a USB connector 106 in communication with the USB interface. The USB connector 106 may be any suitable USB connector including a Type A USB connector, a Type B USB connector, and a mini-USB connector. As shown in FIG. 2, the USB connector 106 is in communication with a USB interface 108 of controller 110.

The USB flash drive 100 of this embodiment also includes a receiver 124 for receiving a signal from an external remote device, which in this embodiment is a remote enabler 150. The USB flash drive 100 also includes a decision component 140 that is in communication with the receiver 124 and with the controller 110. The decision component includes modules for receiving the signal from the receiver 124, decrypting encrypted signals (in one embodiment), determining if the signal is authentic, determining if the signal is still present (in one embodiment), and communicating to the controller 110 if the signal is authentic.

The external remote enabler 150 includes a transmitter 152 for transmitting a signal to the receiver 124 of the USB Flash drive 100. A validation process occurs in the USB flash drive regarding the signal from the remote enabler 150. The signal from the transmitter 152 of the remote enabler is received by the receiver 124 which then communicates that signal to the decision component 140. The decision component compares the signal to criteria and based on the comparison validates the signal or determines the signal not to be valid. If the signal is determined to be valid, then the decision component 140 in conjunction with a controller 110 enables data flow from the USB memory 116. If the signal is determined not to be valid, or if no signal is received, then the controller 110 denies access to the memory storage from a host device via the hardwired connection.

### Second Preferred Embodiment

An alternative embodiment is illustrated in FIG. 3. This embodiment is similar to the above described embodiment except the memory storage 116 is a partitioned memory with public memory 112 and secure memory 114. The public memory may be accessed by a host computer or other device without authentication via pathway 112x. However, access to the secure memory 114 requires authentication before data is allowed to be accessed. The private partition may be hidden, e.g., not exposed, and/or encrypted to protect the data stored in the private partition from unauthorized access. Data from the public memory 112 and the private memory 114 (once authentication has been achieved) flows through the memory interface 118 and communication interface into the host device 102 through connectors 106 and port 104.

### Third Preferred Embodiment

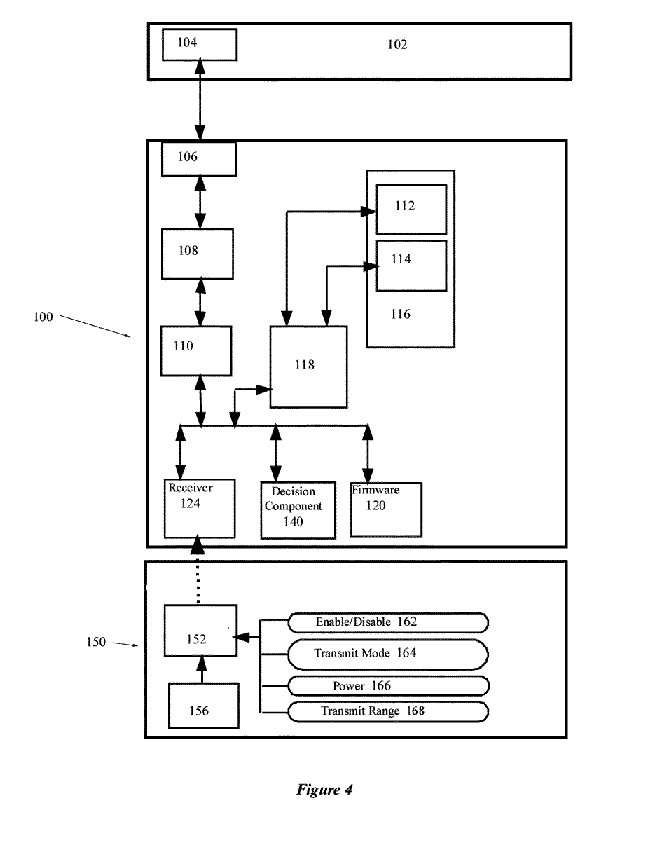

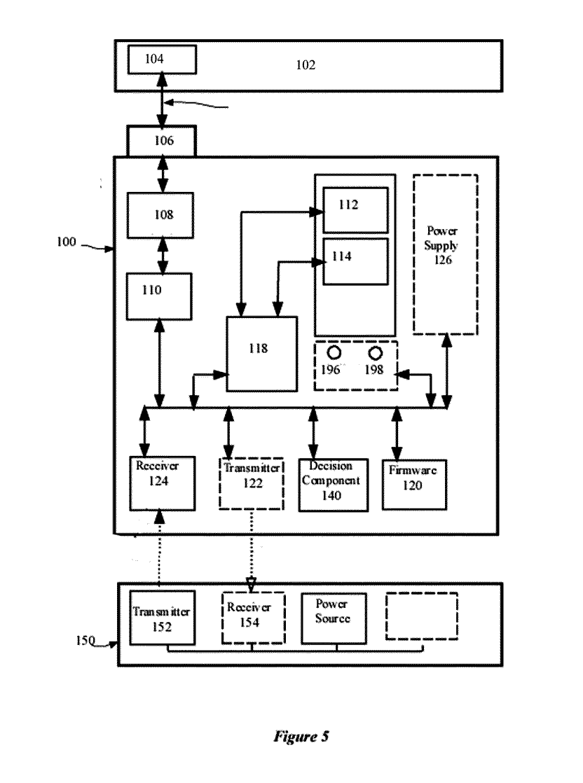

An alternative embodiment of the remote enabler is illustrated in FIG. 4. The signal from the transmitter 152 on the remote enabler 150 can either be transmitted on demand, such as by pushing an activation button 162 on the remote enabler, or it can continuously transmit a signal that is received by the receiver 124 once the remote enabler is in range of the USB flash drive. Alternatively, the external remote enabler can include switches 164 or pushbuttons for selection of mode from continuous transmit to transmit on demand. Also, the signal strength can be adjusted to a high range or low range such as by switch 168.

### Fourth Preferred Embodiment

In an alternative embodiment shown in FIG. 5, the USB flash drive 100 includes an optional transmitter 122 for pinging (i.e. requesting a signal from) the remote enabler 150. The transmitter periodically pings to a receiver 154 on the remote enabler. Once the remote enabler is in range, the receiver 154 is able to receive the signal from the transmitter 122. The receiver then activates the transmitter 152 to send the appropriate signal to the receiver 124 on the USB flash drive.

The USB Flash drive may include an optional power supply 126 useful for powering up the receiver 124 and or transmitter 122 while the USB Flash drive 100 is not connected to a host 102. The power supply 126 can be used to retain the status of the flash drive's enablement, as it is disconnected from the host 102. The power supply 126 may also be useful in powering up circuitry and indicators 196 and 198 during testing of the remote enabler 150 and the validation process. Any suitable power supply 126 and 156 may be used as appropriate in the USB flash drive 100 or the remote enabler 150 including any combination of a battery, a solar power system, a piezoelectric system, a power system energized by an external frequency or magnetic field including those similar to radio frequency identification systems, and the like. For example, the USB flash drive 100 may include a power supply 126 including a battery which may be recharged from time to time by power derived from host computer system 102 through the USB connector and/or a solar power supply such as solar cells. The remote enabler may include a USB connector for the purpose of charging its internal power supply 156.

### Fifth Preferred Embodiment

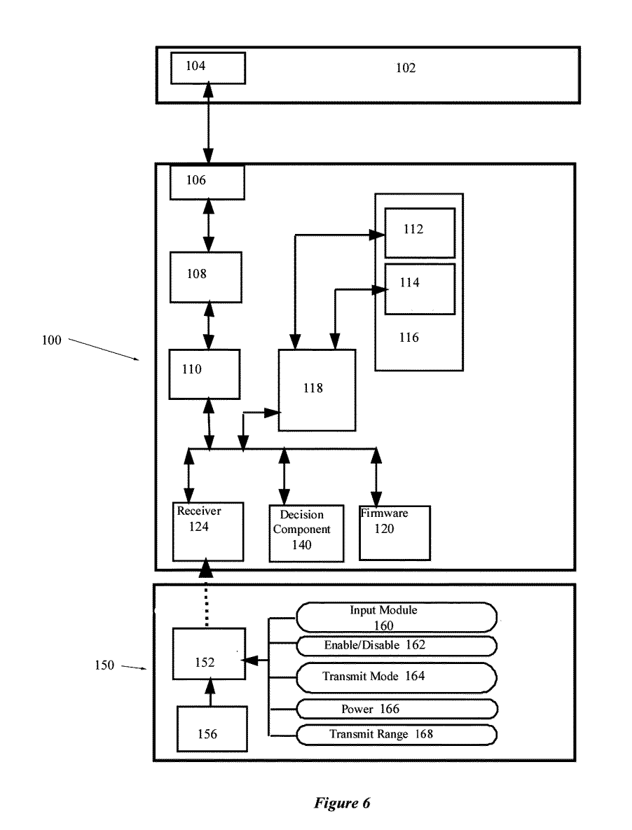

Another alternative embodiment is illustrated in FIG. 6. The PMSD 100 and/or the remote enabler 150 may include switches (such as D.I.P switches) to select or alter or scramble the transmitted signal used in the validation process. The private partition may be hidden, e.g., not exposed, and/or encrypted to protect the data stored in the private partition from unauthorized access. Accordingly, to access the data stored in the private partition, a valid signal (i.e. or authentic credential) must be presented. A credential may be any suitable combination of a password, fingerprint, radio frequency identifier, written signature, voice signature, cryptographic key, retina, facial features, physical key, and the like or the credential may simply be based on the signal pattern, strength or frequency. The credential 160 may be presented to the USB device through any suitable method including via the remote enabler 150.

An input device may be used in conjunction with a remote enabler to provide a signal to the PMSD. The input device 160 may be used to receive biometric data from the user or may simply be a keypad, switch, pushbutton, card reader or other.

The remote enabler 150 may interface with a transducer capable of receiving the types of inputs described above. The wireless signal, after being received, may be authenticated/validated in any suitable manner such as by comparing the received signal and/or the data it contains with a basis credential or criteria. The basis criteria or credential may be pre-stored in the computer readable memory 112 or in the firmware 120 for example. A decision component may compare the received credential with the basis credential or criteria and may be supported by any suitable computing device. The decision component 140 may be a set of computer executable instructions executed by a processor or simple comparators, or analog devices.

In use, the user inputs the required credential into the remote enabler, such as a biometric scan, password, voice recognization, etc via the input device 160. The remote enabler then transmits this credential to the receiver 122 on the USB flash drive. The decision component analyzes this credential by comparing it to criteria that has been selected. If the credential is authentic, then the decision component signals the controller which then allows access to the secure data.

### Sixth Preferred Embodiment

The system of an alternative embodiment of the invention is similar to the above described embodiments. The receiver 122 of this embodiment actively monitors the presence of the transmitted signal. The receiver 122 may do this by actively pinging the transmitter of the remote enabler at periodic intervals so that the transmitter sends a signal back, or the transmitter of the remote enabler continuously or periodically sends a signal to the receiver. If the receiver of this embodiment does not receive the transmitted signal within a predetermined interval, the receiver notifies the decision component and the controller. The controller then denies any further access to the secure memory storage. Thus, the remote enabler must be within the transmittal range in order for the data to be accessed. This prevents access to the secure data when the user leaves the area with the remote enabler, or when remote enabler is deactivated.

Another alternative embodiment demands a constant signal (such as RFID tag) from the transmitter to the receiver. This allows the loss of the connection to between the remote enabler and the USB flash drive to be detected by the USB flash drive. The loss of the signal causes the reset of the authentication process (i.e. requiring re-authentication prior to the next use of the device). The communications which are being enabled via the remote device (RFID tag in this example) may, by way of example may be from secure portions of memory.

Having now described illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, it should be understood that those operations and those elements may be combined in other ways to accomplish the same objectives. Operations, elements, and features discussed only in connection with one embodiment, are not intended to be excluded from a similar role in other embodiments. Moreover, use of ordinal terms such as “first” and “second” in this application does not by itself connote any priority, precedence, or order of one element over another or the temporal order in which operations of a method are performed, but are used merely as labels to distinguish one element having a certain name from another element having a same name (but for use of the ordinal term) to distinguish the elements for the purpose of the claims. The components illustrated can achieve their functionality via hardware, software, firmware or any combination these. The components may be combined or juxtaposed in various manners to perform the same functional results without departing from the scope of this invention.

1. A secure system for use with portable memory storage devices, wherein said system comprises:
a portable memory storage device;
a connector mechanism for connecting said device to a host device;
a computer readable medium on said portable memory storage device;
a controller on said device controlling access to information on said medium;
a receiver on said device for receiving an encrypted external wireless signal;
a decision component that receives the encrypted external wireless signal from said receiver;
a decryption module on said decision component to decrypt the encrypted external wireless signal;
an authentication module on said decision component to determine whether said signal is authentic based on predetermined criteria; and
a communication module on said decision component that communicates authorization to said controller if the signal is authentic.

2. The security system of claim 1 wherein said system further comprises:
a remote enablement device;
a transmitter on said remote enablement device that transmits an external wireless signal to said receiver; and
an encryption module that encrypts the information that is transmitted by said transmitter.

3. The security system of claim 1 wherein said system further comprises:
a handheld remote enablement device;
a transmitter on said remote enablement device that transmits an external wireless signal to said receiver; and
an encryption module that encrypts the information that is transmitted by said transmitter.

4. The security system of claim 1 wherein said system further comprises:
a remote enablement device;
a transmitter on said remote enablement device that transmits an external wireless signal to said receiver;
an encryption module that encrypts the information that is transmitted by said transmitter; and
a switch on said remote enablement device that enables and disables said transmitter.

5. The security system of claim 1 wherein said system further comprises:
a remote enablement device;
a transmitter on said remote enablement device that transmits an external wireless signal to said receiver;
an input module that receives credentials from a user; and
an encryption module that encrypts the user credentials for transmission by said transmitter.

6. The security system of claim 5 wherein said credentials include password information.

7. The security system of claim 5 wherein said credentials include:
biometric information.

8. The security system of claim 1 wherein said system further comprises:
a Wi-Fi device;
a transmitter on said Wi-Fi device that transmits an external wireless signal to said receiver; and
an encryption module that encrypts the information that is transmitted by said transmitter.

9. The security system of claim 1 wherein said system further comprises:
a RFID device; and
a transmitter on said RFID device that transmits an encrypted external wireless signal to said receiver.

10. The security system of claim 1 wherein said system further comprises:
a Bluetooth device;
a transmitter on said Bluetooth device that transmits an external wireless signal to said receiver; and
an encryption module that encrypts the information that is transmitted by said transmitter.

11. The security system of claim 1 wherein said decision component includes:
a signal presence module that determines whether or not an external wireless signal is still present and notifies said controller in the event that the external wireless signal is no longer present so that said controller denies further access to said medium.

12. The security system of claim 1 wherein said computer readable medium includes:
a first partition that allows access to information stored on it regardless of whether the system has been authenticated; and
a second partition where access is controlled by said controller.

13. A security system for use with portable memory storage devices, wherein said system comprises:
a portable memory storage device;
a connector mechanism for engagement with a host device;
a computer readable medium on said device;
a receiver on said device for receiving an external wireless signal;
a controller on said device controlling access to information on said medium;
a decision component on said device that receives the external wireless signal;
an authentication module on said decision component that determines whether the external wireless signal is authentic based on selected input criteria; and
a communication module on said decision component that communicates authorization to said control if the external wireless signal contains authentic input credentials.

14. The security system of claim 13 wherein said system further includes:
a decryption module on said decision component to decrypt the encrypted external wireless signal.

15. The security system of claim 13 wherein said system further includes:
a signal presence module that determines whether or not an external wireless signal is still present and notifies said controller in the event that the external wireless signal is no longer present so that said controller denies further access to said medium.

16. The security system of claim 13 wherein said system further includes:
an enablement device that transmits an external wireless signal to said receiver; and
an input mechanism on said enablement device to allow additional credentials to be entered and transmitted to said receiver to authorize access to said medium.

17. The security system of claim 16 wherein said additional credentials include:
a password.

18. The security system of claim 16 wherein said additional credentials include:
biometric information.

19. The security system of claim 13 wherein said system further includes:
an enablement device that transmits an external wireless signal to said receiver; and
an encryption module that encrypts the information for said enablement device to transmit to said receiver.

20. The security system of claim 13 wherein said system further comprises:
a remote enablement device;
a transmitter on said remote enablement device that transmits an external wireless signal to said receiver;
an encryption module that encrypts the information that is transmitted by said transmitter; and
a switch on said remote enablement device that enables and disables said transmitter.
